(19) United States
(12) Patent Application Publication
(10) Pub. No.: US 2003/0118346 A1
(43) Pub. Date: Jun. 26, 2003

(54) Optical signal generating apparatus, method thereof, transmitting apparatus, transmitting method, receiving apparatus, receiving method, transmitting and receiving apparatus, and transmitting and receiving method

(75) Inventors: Ken Umeno, Tokyo (JP); Wataru Chujo, Tokyo (JP)

Correspondence Address: Randy J. Pritzker, Wolf, Greenfield & Sacks, P.C., 600 Atlantic Avenue, Boston, MA, 02210, US

(73) Assignee: Communications Research Laboratory Independent Administrative Institution, Tokyo (JP)

(21) Appl. No.: 10/315,843

(22) Filed: Dec. 9, 2002

(30) Foreign Application Priority Data
Dec. 11, 2001 (JP) JP2001-377132

(51) Int. Cl. H04J 14/02

(52) U.S. Cl. 398/140; 398/161; 398/201; 398/200; 398/91

(57) ABSTRACT

Four optical interferometers are arranged in parallel. Optical path length differences of the optical interferometers are set to L, r×L, r×r×L, and r×r×r×L, respectively, where L is a unit optical path length difference (constant). A coefficient r by which the unit optical path length difference L is multiplied is any non-integer real number for example an irrational number. An irrational number is for example a surd (√2, √3, etc.), ratio of circumference D, or base e of a natural logarithm. When such optical path length differences are set in such a manner, a chaotic dynamical system, an addition theorem, and a chaotic map are not satisfied with respect to the intensities of light which is output from the optical interferometers. In other words, a thoroughly unpredictable sequence can be generated. The sequence is spectrum spread as spread codes.

### BACKGROUND OF THE INVENTION

1. Field of the Invention

The present invention relates to an optical signal generating apparatus, a method thereof, a transmitting apparatus, a transmitting method, a receiving apparatus, a receiving method, a transmitting and receiving apparatus, and a transmitting and receiving method which are applicable for transmitting and receiving spectrum spread data using a very high speed optical device.

2. Description of the Related Art

A spread spectrum method has been used in for example a CDMA (Code Division Multiple Access) cellular phone and wireless LAN (Local Area Network). When the spread spectrum method is used, a base band signal is modulated on a transmission side. The modulated signal is input to a spreading circuit. The spreading circuit spectrum spreads the signal with spreading codes. On a receiver side, with the same spread codes as the transmission side, a spectrum spread signal is inversely spread and demodulated. As a result, a base band signal is obtained. A spread spectrum method using an optical device which operates at a higher speed than an electronic device has been proposed (see for example Japanese Patent Laid-Open Publication No. 2000-206472 and Japanese Patent Laid-Open Publication No. 2001-13532).

Japanese Patent Laid-Open Publication No. 2000-206472 describes a circuit which optically generates chaotic random numbers expressed by a chaotic dynamical system. The circuit uses an optical random number generating circuit which comprises an optical pulse sequence generator, a plurality of Mach-Zehnder optical interferometers, and an optical delaying circuit. On the other hand, Japanese Patent Laid-Open Publication No. 2001-13532 discloses a technology of which optical random numbers generated by the optical random number generating circuit and an input optical signal are multiplied by an optical multiplying circuit so as to spectrum spread the optical signal.

For easy understanding for the present invention, the optical random number generating circuit and the optical signal modulating circuit disclosed in the forgoing documents will be described. FIG. 1 shows the overall structure of the optical signal modulating circuit. An optical signal is input from an input terminal 71. The optical signal is received by an optical input receiving portion 72. An optical short pulse light source 73 is composed of a mode lock semiconductor laser. An optical short pulse generated by the optical short pulse light source 73 is split into for example four optical interferometers 74₁ to 74₄. Each of the optical interferometers 74₁ to 74₄ is composed of a Mach-Zehnder optical interferometer.

Optical signals which are output from the optical interferometers 74₁ to 74₄ are delayed by an optical delaying circuit 75 for predetermined time periods. The delayed optical signals are combined by the optical delaying circuit 75. The combined optical signal is input to an optical multiplying circuit 76. The input optical signal, which is received by the optical input receiving portion 72, is also input to the optical multiplying circuit 76. The optical delaying circuit 75 outputs optical chaos spread codes generated by the optical interferometers 74₁ to 74₄. The optical multiplying circuit 76 modulates the input optical signal with the optical chaos spread codes corresponding to the spread spectrum method. A modulated optical output signal is output from the optical multiplying circuit 76 to an output terminal 77.

FIG. 2 shows a practical structure of the forgoing optical interferometers 74₁ to 74₄. Two optical waveguides are disposed between 1×2 optical splitting devices 81₁ to 81₄ and 2×1 optical coupling devices 83₁ to 83₄, respectively. Between the two optical waveguides, optical path length differences 82₁ to 82₄ are set. The optical splitting devices 81₁ to 81₄ and the optical coupling devices 83₁ to 83₄ can be composed of the same couplers. When the same couplers are used in different orientations, optical splitting devices and optical coupling devices can be accomplished.

The optical path length differences 82₁, 82₂, 82₃, and 82₄ of the optical interferometers are set so that they form geometric progression sequences with a common ratio of m (where m is any integer which is 2 or larger). In other words, the optical path length differences 82₁ to 82₄ of the four optical interferometers 64₁ to 64₄ are set to L, m×L, m×m×L, and m×m×m×L, respectively (where L is a unit optical path length difference (constant)).

When the optical path length differences are set in such a manner, assuming that the intensities of light which is output from the optical interferometers 64₁ to 64₄ are X[1], X[2], X[3], and X[4], respectively, regardless of the wavelength of the optical signal of the optical short pulse light source, the relation (dynamic system) of the following formula (1) is satisfied.

X[i+1]=F(X[i]) (1)

where F(sin²θ)=sin²mθ

In other words, when the optical path length differences of the Mach-Zehnder optical interferometers satisfy the forgoing relation, optical powers thereof satisfy a dynamical system produced by a map F (·) obtained from an addition theorem of a trigonometric function.

When m=2, the map F is a logistic map (formula (3)). When m=3, the map F is a cubic map (formula (4)). Generally, these maps are referred to as Chebyshev map. It is known that a signal which is output corresponding to a recurrence formula using the map F or the map G chaotically acts.

F(x)=4x(1−x) (3)

F(x)=x(3−4x)² (4)

With such random numbers, an optical signal is spectrum spread.

As was described above, in the proposed optical random number generating circuit, the coefficient m by which the unit optical path length difference L is multiplied is any integer which is 2 or larger. As a result, a sequence expressed by the chaotic dynamical system represented by the formula (1) is generated. In a sequence expressed by such a deterministic equation, X[i+1] can be predicted from X[i]. Consequently, in the spread spectrum communication system, secrecy may be insufficient.

In the second related art reference as Japanese Patent Laid-Open Publication No. 2001-13532, as the optical multiplying circuit, a nonlinear fiber loop mirror is used. However, such an optical multiplying circuit cannot use a high speed optical modulator such as an electrooptic modulator which obtains an optical signal which has been modulated with a conventional electric signal. Moreover, in the optical multiplying circuit, the wavelength of light generated by the optical pulse generator should match the wavelength of the input optical signal. Thus, it is difficult to accomplish a wavelength multiplexing system of which a large amount of information is divided into optical signals having many different wavelengths. In addition, it was difficult to transmit a large amount of information with high security.

### OBJECTS AND SUMMARY OF THE INVENTION

Therefore, an object of the present invention is to provide an optical signal generating method and an apparatus thereof which allow an optical device to generate a thoroughly unpredictable sequence.

Another object of the present invention is to provide a transmitting apparatus, a transmitting method, a receiving apparatus, a receiving method, a transmitting and receiving apparatus, and a transmitting and receiving method for use with a large capacity, high speed, high security communication system which can use an optical modulator obtaining an optical signal modulated with an electric signal, which can modulates and demodulates with a chaotic signal, and which can easily accomplish a wavelength multiplexing system.

A first aspect of the present invention is an optical signal generating apparatus, comprising:

a plurality of optical interferometers, each of which is configured to split input light into beams, input the split beams to a first optical path and a second optical path, and combine the beams which are passed through the first optical path and the second optical path,

wherein the optical signal generating apparatus is configured to split light into beams, supply the split beams to the optical interferometers, and combine beams which are output from the optical interferometers, and

wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

A second aspect of the present invention is an optical signal generating method of which the coefficient r is any non-integer real number.

A third aspect of the present invention is a transmitting apparatus, comprising:

optical modulating means for optically modulating an intensity or a phase of an optical pulse sequence generated by a light source for optical pulses with an electric transmission signal; and

an encoder of full wave type for receiving an optical pulse sequence from the optical modulating means and outputting an optical signal which has been spectrum spread,

wherein the encoder comprises:

a splitting device for splitting input light into a plurality of beams;

a plurality of optical interferometers for inputting a plurality of beams; and

an optical delaying circuit for delaying output beams of the optical interferometers as arithmetic progression sequences and combining the delayed output beams, and

wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

A fourth aspect of the present invention is a transmitting method of which the coefficient r is any non-integer real number.

A fifth aspect of the present invention is a receiving apparatus for receiving an optical signal from a transmitting apparatus comprising optical modulating means for optically modulating an intensity or a phase of an optical pulse sequence generated by a light source for optical pulses with an electric transmission signal; and an encoder of full wave type for receiving an optical pulse sequence from the optical modulating means and outputting an optical signal which has been spectrum spread, wherein the encoder comprises a splitting device for splitting input light into a plurality of beams; a plurality of optical interferometers for inputting a plurality of beams; and an optical delaying circuit for delaying output beams of the optical interferometers as arithmetic progression sequences and combining the delayed output beams, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number, the receiving apparatus, comprising:

a decoder for inversely spreading the optical signal; and

a receiver for generating a reception signal corresponding to an intensity or phase of the optical pulse sequence received from the decoder,

wherein the decoder comprises:

an optical delaying circuit for splitting an input pulse light into a plurality of pulse beams and delaying the pulse beams as arithmetic progression sequences so as to cancel the delay of the pulse beams, the delay being given by the encoder; and

a plurality of optical interferometers for inputting a plurality of beams which are output from the optical delaying circuit, and

wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

A sixth aspect of the present invention is a receiving method of which the coefficient r is any non-integer real number.

A seventh aspect of the present invention is a transmitting and receiving apparatus for transmitting an optical signal from a transmitting apparatus to a receiving apparatus through an optical transmission path,

wherein the transmitting apparatus comprises: optical modulating means for optically modulating an intensity or a phase of an optical pulse sequence generated by a light source for optical pulses with an electric transmission signal; and an encoder of full wave type for receiving an optical pulse sequence from the optical modulating means and outputting an optical signal which has been spectrum spread, wherein the encoder comprises: a splitting device for splitting input light into a plurality of beams; a plurality of optical interferometers for inputting a plurality of beams; and an optical delaying circuit for delaying output beams of the optical interferometers as arithmetic progression sequences and combining the delayed output beams, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number, and

wherein the receiving apparatus comprises: a decoder for inversely spreading an optical signal received for the transmitting apparatus; and a receiver for generating a reception signal corresponding to an intensity or phase of the optical pulse sequence received from the decoder, wherein the decoder comprises: an optical delaying circuit for splitting an input pulse light into a plurality of pulse beams and delaying the pulse beams as arithmetic progression sequences so as to cancel the delay of the pulse beams, the delay being given by the encoder; and a plurality of optical interferometers for inputting a plurality of beams which are output from the optical delaying circuit, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

An eighth aspect of the present invention is a transmitting and receiving method of which the coefficient r is any non-integer real number.

According to the present invention, a thoroughly unpredictable sequence can be generated. Thus, when such a sequence is used as spread codes, the secrecy of communication can be improved. In addition, according to the present invention, an optical modulation can be performed with an electric signal. Thus, a high speed optical modulator such as a conventional electrooptical modulator can be used. In addition, according to the present invention, since a modulated optical signal is spread, a wavelength multiplexing method can be used.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a block diagram showing an optical modulating device which has been proposed.

FIG. 2 is a block diagram showing an optical signal generating apparatus used in the optical modulating device which has been proposed.

FIG. 3 is a block diagram showing an outlined structure of a transmitting apparatus and a receiving apparatus according to an embodiment of the present invention.

FIG. 4 is a schematic diagram showing an outlined structure of pulses generated by a mode locked laser diode.

FIG. 5 is a block diagram showing the structure of which the present invention is applied for a wavelength multiplexing method.

FIG. 6 is a block diagram showing an example of the structure of an encoder according to an embodiment of the present invention.

FIG. 7 is a block diagram showing an example of the structure of an inputting portion of the encoder.

FIG. 8A is a block diagram showing one example of an optical interferometer.

FIG. 8B is a block diagram showing another example of an optical interferometer.

FIG. 9 is a block diagram showing the structure of a part of the encoder.

FIG. 10 is a block diagram showing the structure of a part of the encoder.

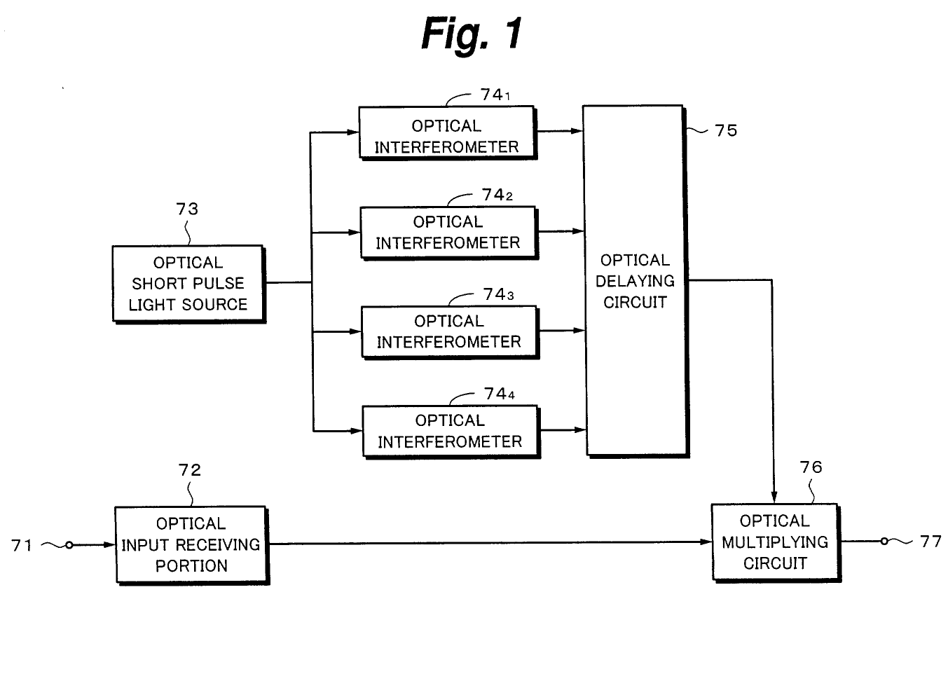

### DETAILED DESCRIPTION OF THE PREFERRED EMBODIMENTS

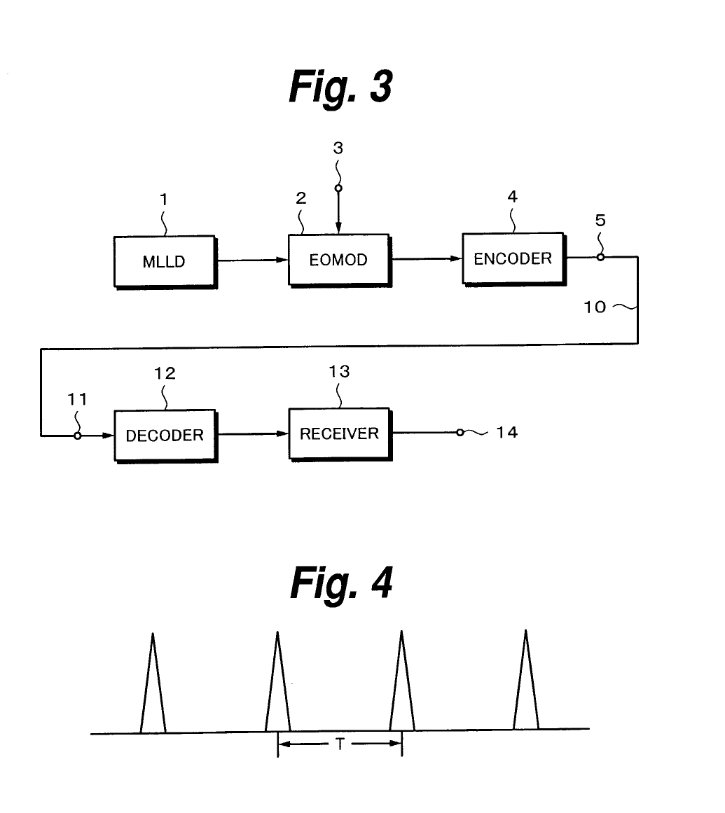

Next, with reference to the accompanying drawings, an embodiment of the present invention will be described. FIG. 3 shows an outlined structure of a transmitting apparatus and a receiving apparatus according to the embodiment of the present invention. The transmitting apparatus comprises a mode locked laser diode 1 which is a light source for optical pulses, an electrooptical modulator 2, and an encoder 4 which spectrum spreads an optical signal. As shown in FIG. 4, the mode locked laser diode 1 generates an optical pulse sequence with a period T. For example, the mode locked laser diode 1 generates an optical pulse sequence with a period T of 100 psec (10 GHz in frequency). Besides the mode locked laser diode, as the light source for optical pulses, a combination of a mode locked fiber laser, a light source for a continuous wave, and an electroabsorption optical modulator can be used.

Electrical digital transmission data is supplied from an input terminal 3 to the electrooptical modulator 2. The electrooptical modulator 2 modulates the intensities or phases of optical pulses with the transmission data. The electrooptical modulator 2 modulates the intensity or phase of each optical pulse corresponding to the value of each bit of data. The electrooptical modulator 2 uses the electro-optical effect. Thus, hereinafter, the electrooptical modulator 2 is sometimes referred to as EO modulator. Using the theory of which the reflective index varies in proportion to the intensity of the electric field, the EO modulator 2 modulates the optical pulse sequence of the mode locked laser diode 1 corresponding to the digital transmission data (voltage). In other words, the EO modulator 2 modulates the intensities of optical pulses corresponding to the digital transmission data. Alternatively, the EO modulator 2 can modulate the phases of the optical pulse sequence. Thus, the EO modulator 2 can use any one of intensity modulation and phase modulation. According to the present invention, besides the EO modulator, another type high speed modulator such as an electroabsorption optical modulator can be used.

As will be described later, the encoder 4 is of full wave type. The encoder 4 spectrum spreads a modulated optical pulse signal supplied from the EO modulator 2. The encoder 4 outputs the resultant optical signal to an output terminal 5. The optical signal is transmitted through an optical fiber 10 as an optical transmission cable.

The receiving apparatus comprises a decoder 12 and a receiver 13. Reception digital data as an electric signal is output from the receiver 13 to an output terminal 14. The decoder 12 is of full wave type. The decoder 12 inputs an optical signal from an input terminal 11. The decoder 12 has a structure complementary to the encoder 4 disposed on the transmission side. The decoder 12 inversely spreads the reception signal. The receiver 13 outputs a demodulated signal corresponding to the intensities or phases of the optical pulse sequence.

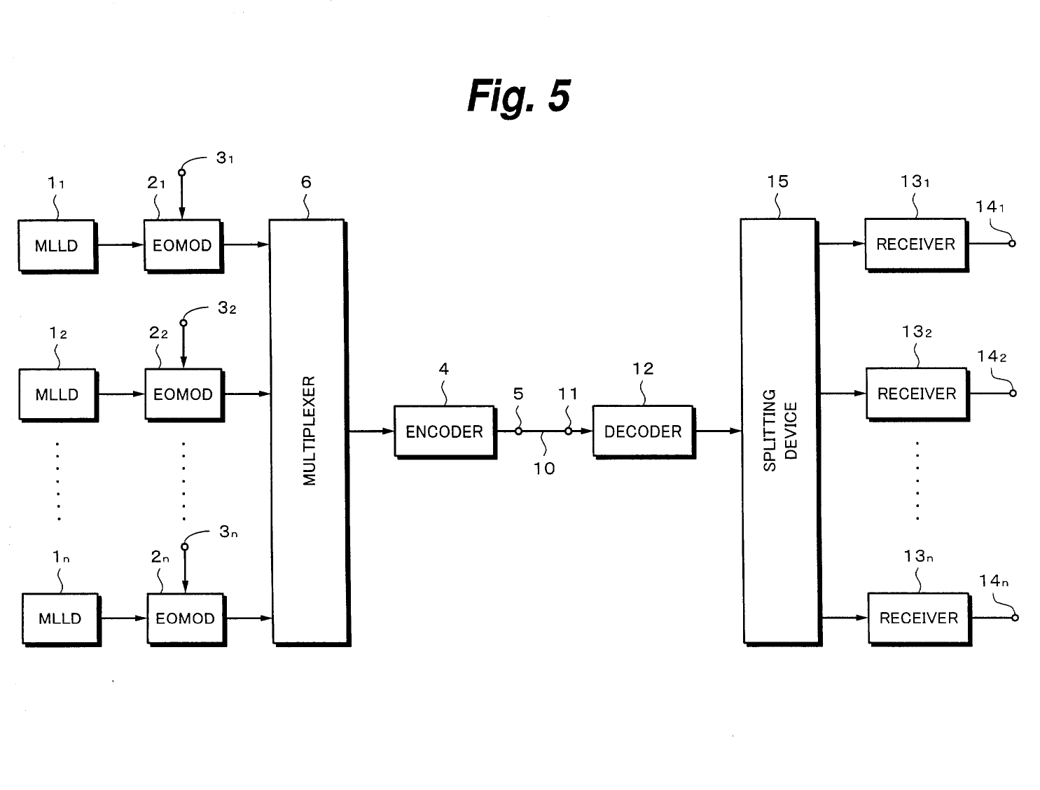

FIG. 5 shows an example of the structure of which the present invention is applied for a wavelength multiplexing system. Referring to FIG. 5, mode locked laser diodes 1₁ to 1ₙ which generate optical pulse sequences having different wavelengths λ1 to λn, respectively are disposed. Since a mode locked laser diode structured as one device generates a plurality of laser beams having different wavelengths, it is not necessary to disposed n devices for generating laser beams having n wavelengths. Laser beams generated by individual mode locked laser diodes are input to EO modulators 2₁ to 2ₙ, respectively. Transmission signals of n channels are input from terminals 3₁ to 3ₙ to the EO modulators 2₁ to 2ₙ, respectively. The EO modulators 2₁ to 2ₙ output optical signals whose intensities or phases have been modulated corresponding to the transmission signals. A multiplexer 6 wavelength multiplexes optical signals of n channels. An output signal of the multiplexer 6 is input to the encoder 4. The encoder 4 outputs a wavelength multiplexed optical signal to the output terminal 5.

On the reception side, the decoder 12 performs an inversely spreading process and inputs a wavelength multiplexed optical signal to a demultiplexer 15. The demultiplexer 15 distinguishes wavelengths and outputs optical signals of n channels. The optical signals of the individual channels are input to receivers 13₁ to 13ₙ, respectively. The receivers 13₁ to 13ₙ output reception signals to output terminals 14₁ to 14ₙ, respectively. As was described above, according to the embodiment of the present invention, optical signals can be easily wavelength multiplexed unlike with a structure which multiplies optical signals.

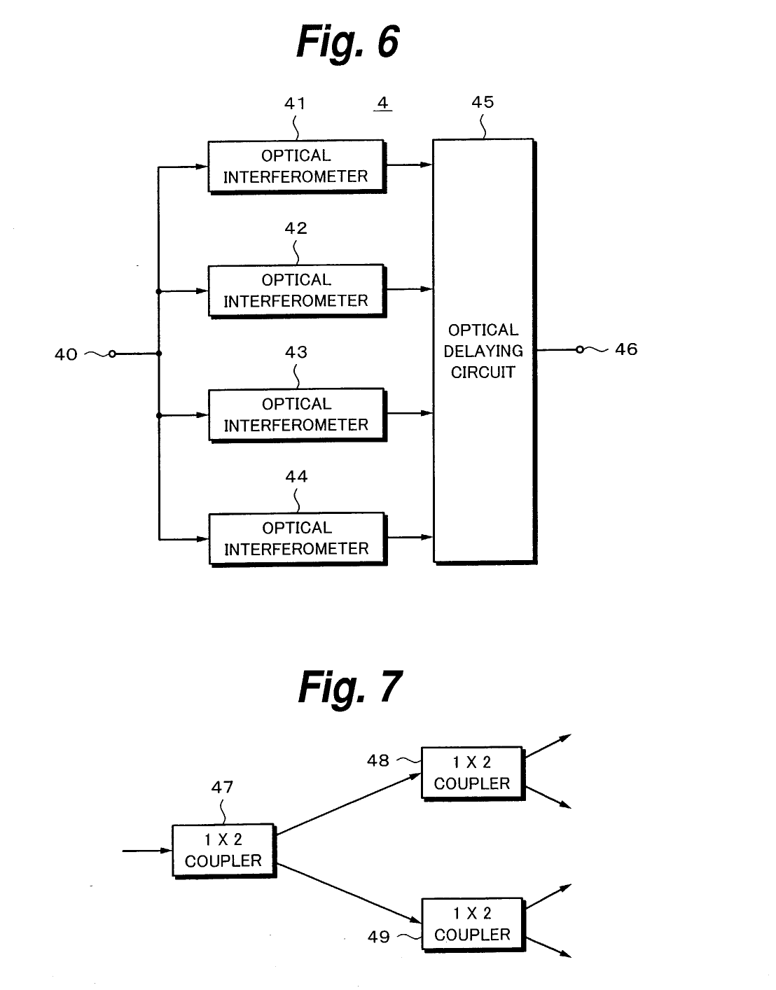

Next, the encoder 4 according to the embodiment of the present invention will be described. FIG. 6 shows an example of the structure of the encoder 4. An optical pulse sequence modulated by the EO modulator 2 is input from an input terminal 40 to a plurality of optical interferometers, for example four optical interferometers 41, 42, 43, and 44. It should be noted that the number of optical interferometers is not limited to four, but any integer number equal to or larger than two.

To guide a modulated optical pulse sequence to the optical interferometers 41 to 44, a structure shown in FIG. 7 can be used. A 1×2 (which represents one input and two outputs) optical splitting device 47 splits an optical pulse sequence into two optical paths. In addition, a 1×2 optical splitting device 48 and a 1×2 optical splitting device 49 each split an optical pulse sequence into two paths. As a result, one optical pulse sequence is split into four optical paths. The split optical pulse sequences are guided to the optical interferometers 41 to 44.

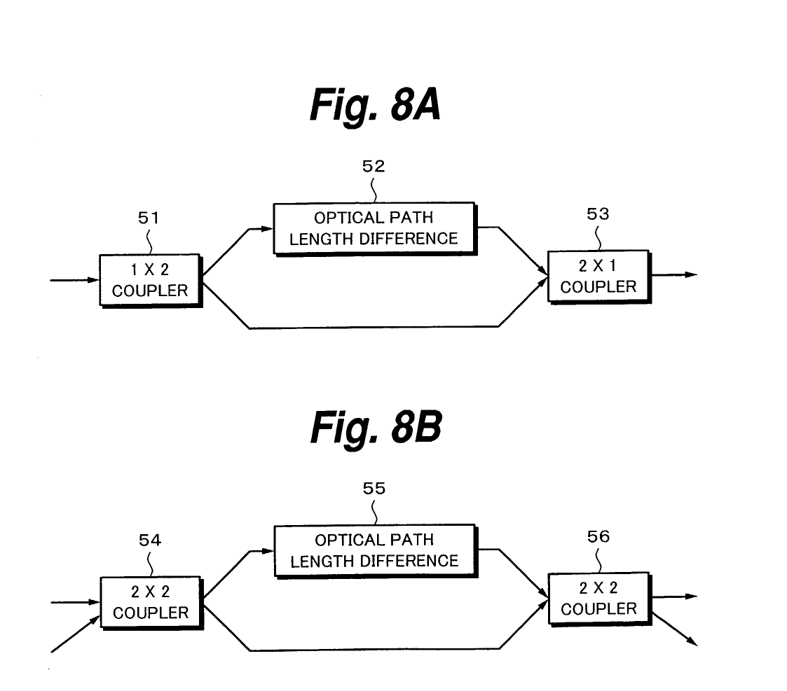

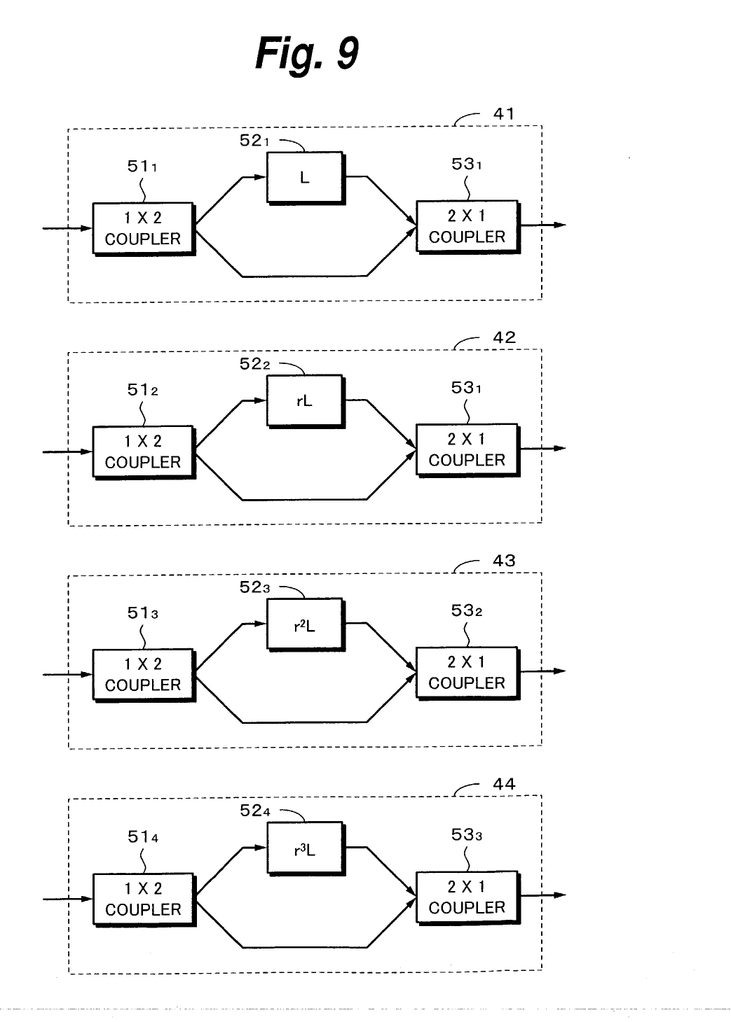

The optical interferometers 41 to 44 each have a structure using a Mach-Zehender interferometer shown in FIG. 8A or 8B. In the structure shown in FIG. 8A, two optical waveguides are disposed between a 1×2 optical splitting device 51 and a 2×1 optical coupling device 53. An optical path length difference 52 is set between the two optical waveguides. The optical splitting device 51 and the optical coupling device 53 are composed of the same couplers. Since the same couplers are used in the different orientations, the optical splitting device 51 and the optical coupling device 53 can be accomplished.

FIG. 8B shows an example of the structure of a Mach-Zehnder optical interferometer. A Mach-Zehnder optical interferometer can be composed of a 2×2 optical splitting device 54 and a 2×2 optical coupling device 56. Two optical waveguides are disposed between the optical splitting device 54 and the optical coupling device 56. An optical path length difference 55 is set between the two optical waveguides.

FIG. 9 shows a real structure of which four optical interferometers 41 to 44 are arranged in parallel. In the structure shown in FIG. 9, optical interferometers shown in FIG. 8A are used. Optical path length differences 52₁, 52₂, 52₃, and 52₄ of the optical interferometers are set so that they form geometric progression sequences with a common ratio r. In other words, the optical path length differences 52₁ to 52₄ of the four optical interferometers 41 to 44 are set to L, r×L, r×r×L, and r×r×r×L, respectively (where L is a unit optical path length difference (constant)). Generally, the optical path length difference L(j+1) of the (j+1)-th optical interferometer and the optical length difference L(j) of the j-th optical interferometer have the relation of (L(j+1)=rL(j)).

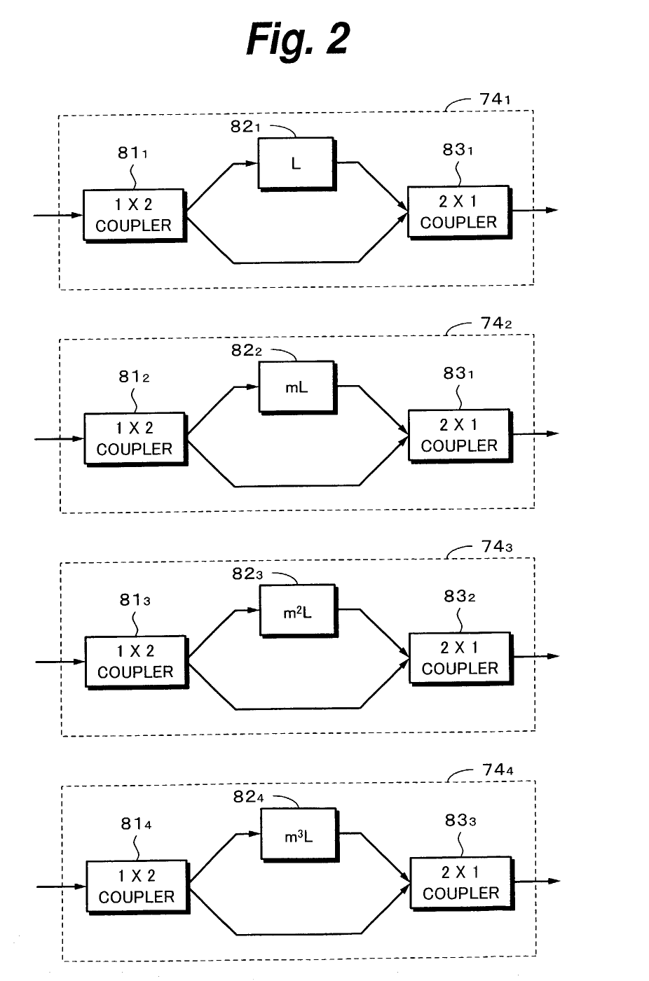

The proposed structure of which optical interferometers are arranged as shown in FIG. 2 is the same as the structure according to the embodiment shown in FIG. 9. In the structure shown in FIG. 2, the coefficient m by which the unit optical path length difference L is multiplied is any integer which is 2 or larger. In contrast, according to the present invention, the coefficient r by which the unit optical path length difference L is multiplied is any real number which is not an integer. In a set of real numbers, numbers which are not rational numbers are irrational numbers. For example, surds such as √2 and √3, the ratio of circumference D, and the base e of a natural logarithm are irrational numbers. In addition, rational numbers have two integers a and b (b≠0) which can be expressed as a fraction a/b. Integers are rational numbers which particularly satisfy b=1. Real numbers are a set of rational numbers and irrational numbers. Irrational numbers and non-integer rational numbers are used as r. In particular, non-integer rational numbers which are indivisible can be used as r.

When optical path length differences are set in such a manner, the relation (dynamical system) of the formula (1), the addition theorem, and the chaotic map cannot be satisfied with respect to the intensities of light which is output from the optical interferometers 41 to 44. In other words, with such optical path length differences, a sequence which cannot be described with the formula (1) as a chaotic dynamical system, namely, a thoroughly unpredictable sequence which cannot be described with a deterministic equation, can be generated. With a return map of X[i] and X[i+1], a one-dimensional map such as a chaotic dynamical system is not obtained, but a map of which codes are arranged on a plane. In other words, a sequence of which X[i+1] cannot be predicted from X[i] can be generated.

When a Mach-Zehnder optical interferometer shown in FIG. 8B is used, an optical signal is input to one of two input ports. No optical signal is input to the other input port (namely, the other input port is open).

The optical interferometers 41 to 44 output optical signals in parallel. These optical signals are converted into a serial signal so that they are spectrum spread. An optical delaying circuit 45 delays optical pulse sequences which are output from the optical interferometers 41 to 44 by predetermined time periods, couples these sequences, and outputs the coupled optical pulse sequence. In other words, the optical delaying circuit 45 converts parallel sequences into a serial sequence.

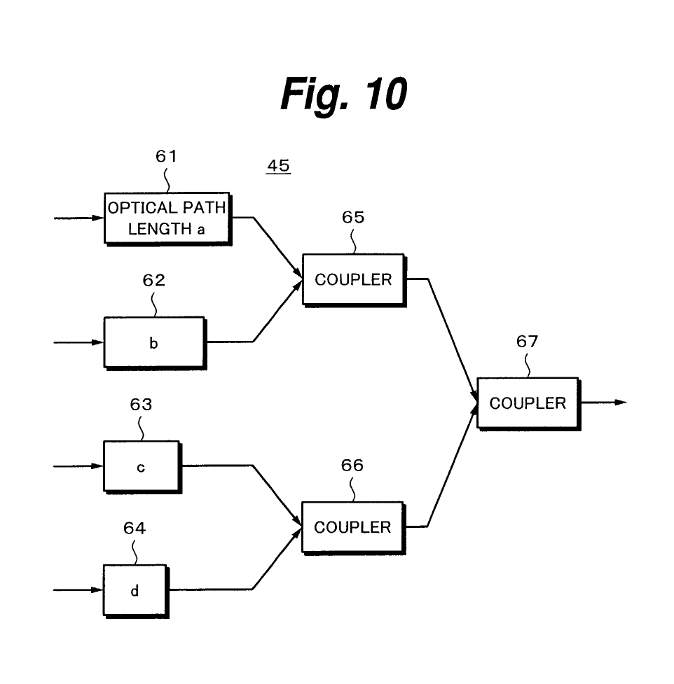

FIG. 10 is an example of the structure of the optical delaying circuit 45. Output signals of the four optical interferometers 41 to 44 are coupled by 2×1 optical coupling devices 65, 66, and 67 through optical path lengths 61 to 64 and converted into one serial signal. The optical path lengths 61 to 64 have different lengths a, b, c, and d, respectively. Typically, the optical path lengths a, b, c, and d have the relation of arithmetic progression sequences. A signal which is output from the optical delaying circuit 45 (namely, an output signal of the encoder 4) is an optical signal which has been spectrum spread.

In the optical path lengths of the optical delaying circuit 45, the shortest optical path length d is subtracted from the longest optical path length a. The subtracted result is divided by the speed of light in the optical fiber. The resultant value is equal to time necessary for which all spread codes corresponding to one optical pulse are output. When parallel sequences are converted into a serial sequence, the output order of X[1], X[2], X[3], and X[4] can be freely pre-designated.

The decoder 12 disposed on the reception side performs an inverse process of the forgoing encoder 4. In other words, the decoder gives optical path lengths which are arithmetic progression sequences to the serial sequence so as to cancel the optical path lengths given by the encoder. As a result, the decoder 12 converts the serial sequence into parallel sequences and inputs them to a plurality of optical interferometers (in this example, four optical interferometers). The optical interferometers inversely spread the sequences. The four optical signals are multiplexed to one modulated optical pulse sequence. The multiplexed sequence is guided to the receiver 13. In the optical interferometers, the optical path length difference L(j+1) of the (j+1)th optical interferometer and the optical path length difference L(j) of the j-th optical interferometer have the relation of (L(j+1)=rL(j)), where the coefficient r is a non-integer real number which matches the coefficient r on the reception side.

The receiver 13 detects the variation of the intensity or phase of the optical pulse sequence. The receiver 13 is composed of for example a photo detector which can operate at high speed. The receiver 13 generates an output electric signal which corresponds to the variation of the intensity or phase of the optical pulse sequence.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention. For example, the optical path length of the optical delaying circuit as a structural element of the encoder can be properly designated in consideration of the period of the optical pulse sequence.

According to the present invention, an optical modulation is performed with an electric signal unlike with the prior art using an optical multiplying circuit. Thus, a structure suitable for a conventional communication system can be accomplished. In addition, according to the present invention, an optically modulated output is chaotically encoded, a wavelength multiplexing system can be easily used. As a result, an optical communication system which can transmit a large amount of information with high security can be accomplished. In particular, according to the present invention, a thoroughly unpredictable sequence can be generated and the sequence is spectrum spread. As a result, the security of the sequence can be further improved.

What is claimed is:

1. An optical signal generating apparatus, comprising:
a plurality of optical interferometers, each of which is configured to split input light into beams, input the split beams to a first optical path and a second optical path, and combine the beams which are passed through the first optical path and the second optical path,
wherein the optical signal generating apparatus is configured to split light into beams, supply the split beams to the optical interferometers, and combine beams which are output from the optical interferometers, and
wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

2. An optical signal generating method, comprising the steps of:
providing a plurality of optical interferometers, each of which is configured to split input light into beams, input the split beams to a first optical path and a second optical path, and combine the beams which are passed through the first optical path and the second optical path;
splitting light into beams and supplying the split beams to the optical interferometers; and
combining beams which are output from the optical interferometers,
wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

3. A transmitting apparatus, comprising:
optical modulating means for optically modulating an intensity or a phase of an optical pulse sequence generated by a light source for optical pulses with an electric transmission signal; and
an encoder of full wave type for receiving an optical pulse sequence from the optical modulating means and outputting an optical signal which has been spectrum spread,
wherein the encoder comprises:
a splitting device for splitting input light into a plurality of beams;
a plurality of optical interferometers for inputting a plurality of beams; and
an optical delaying circuit for delaying output beams of the optical interferometers as arithmetic progression sequences and combining the delayed output beams, and
wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

4. The transmitting apparatus as set forth in claim 3,
wherein the light source for optical pulses is a mode locked laser diode.

5. The transmitting apparatus as set forth in claim 3,
wherein the optical modulating means is electrooptical modulating means.

6. The transmitting apparatus as set forth in claim 3,
wherein the light source for optical pulses is configured to generate a plurality of optical pulse sequences having different wavelengths, and
wherein the optical pulse sequences are optically modulated and multiplexed.

7. A transmitting method, comprising the steps of:
optically modulating an intensity or a phase of an optical pulse sequence generated by a light source for optical pulses with an electric transmission signal; and
spectrum spreading an optical pulse sequence which has been optically modulated,
wherein the spectrum spreading step is performed by:
splitting input light into a plurality of beams;
inputting a plurality of beams to a plurality of optical interferometers; and
delaying output beams of the optical interferometers as arithmetic progression sequences and combining the delayed output beams, and
wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

8. The transmitting method as set forth in claim 7,
wherein the light source for optical pulses is a mode locked laser diode.

9. The transmitting method as set forth in claim 7,
wherein the optical modulating step is configured to use an electrooptical effect.

10. The transmitting method as set forth in claim 7,
wherein the light source for optical pulses is configured to generate a plurality of optical pulse sequences having different wavelengths, and
wherein the optical pulse sequences are optically modulated and multiplexed.

11. A receiving apparatus for receiving an optical signal from a transmitting apparatus comprising optical modulating means for optically modulating an intensity or a phase of an optical pulse sequence generated by a light source for optical pulses with an electric transmission signal; and an encoder of full wave type for receiving an optical pulse sequence from the optical modulating means and outputting an optical signal which has been spectrum spread, wherein the encoder comprises a splitting device for splitting input light into a plurality of beams; a plurality of optical interferometers for inputting a plurality of beams; and an optical delaying circuit for delaying output beams of the optical interferometers as arithmetic progression sequences and combining the delayed output beams, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number, the receiving apparatus, comprising:
a decoder for inversely spreading the optical signal; and
a receiver for generating a reception signal corresponding to an intensity or phase of the optical pulse sequence received from the decoder,
wherein the decoder comprises:
an optical delaying circuit for splitting an input pulse light into a plurality of pulse beams and delaying the pulse beams as arithmetic progression sequences so as to cancel the delay of the pulse beams, the delay being given by the encoder; and
a plurality of optical interferometers for inputting a plurality of beams which are output from the optical delaying circuit, and
wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

12. The receiving apparatus as set forth in claim 11,
wherein the receiver is configured to generate reception data corresponding to an intensity or phase of the optical pulse sequence, the intensity or phase being determined with a threshold value.

13. A receiving method for receiving an optical signal from a transmitting apparatus comprising optical modulating means for optically modulating an intensity or a phase of an optical pulse sequence generated by a light source for optical pulses with an electric transmission signal; and an encoder of full wave type for receiving an optical pulse sequence from the optical modulating means and outputting an optical signal which has been spectrum spread, wherein the encoder comprises a splitting device for splitting input light into a plurality of beams; a plurality of optical interferometers for inputting a plurality of beams; and an optical delaying circuit for delaying output beams of the optical interferometers as arithmetic progression sequences and combining the delayed output beams, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number, the receiving method, comprising the steps of:
inversely spreading the optical signal; and
generating a reception signal corresponding to an intensity or phase of the optical pulse sequence obtained at the inversely spreading step,
wherein the inversely spreading step is performed by:
splitting an input pulse light into a plurality of pulse beams, delaying the pulse beams as arithmetic progression sequences so as to cancel the delay of the pulse beams given by the encoder, and inputting a plurality of beams which have been delayed to a plurality of optical interferometers, and
wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

14. The receiving method as set forth in claim 13,
wherein the reception data generating step is performed by generating reception data corresponding to an intensity or phase of the optical pulse sequence, the intensity or phase being determined with a threshold value.

15. A transmitting and receiving apparatus for transmitting an optical signal from a transmitting apparatus to a receiving apparatus through an optical transmission path,
wherein the transmitting apparatus comprises: optical modulating means for optically modulating an intensity or a phase of an optical pulse sequence generated by a light source for optical pulses with an electric transmission signal; and an encoder of full wave type for receiving an optical pulse sequence from the optical modulating means and outputting an optical signal which has been spectrum spread, wherein the encoder comprises: a splitting device for splitting input light into a plurality of beams; a plurality of optical interferometers for inputting a plurality of beams; and an optical delaying circuit for delaying output beams of the optical interferometers as arithmetic progression sequences and combining the delayed output beams, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number, and
wherein the receiving apparatus comprises: a decoder for inversely spreading an optical signal received for the transmitting apparatus; and a receiver for generating a reception signal corresponding to an intensity or phase of the optical pulse sequence received from the decoder, wherein the decoder comprises: an optical delaying circuit for splitting an input pulse light into a plurality of pulse beams and delaying the pulse beams as arithmetic progression sequences so as to cancel the delay of the pulse beams, the delay being given by the encoder; and a plurality of optical interferometers for inputting a plurality of beams which are output from the optical delaying circuit, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.

16. A transmitting and receiving method for transmitting an optical signal from a transmitting apparatus to a receiving apparatus through an optical transmission path, the method comprising the steps of:
optically modulating an intensity or a phase of an optical pulse sequence generated by a light source for optical pulses with an electric transmission signal;
spectrum spreading an optical pulse sequence which has been spectrum spread, wherein the spectrum spreading step is performed by splitting input light into a plurality of beams; inputting the beams to a plurality of optical interferometers; delaying output beams of the optical interferometers as arithmetic progression sequences; and combining the delayed output beams, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number;
inversely spreading a received optical signal; and
generating a reception signal corresponding to an intensity or phase of the optical pulse sequence obtained at the inversely spreading step, wherein the inversely spreading step is performed by splitting an input pulse light into a plurality of pulse beams; delaying the pulse beams as arithmetic progression sequences so as to cancel the delay of the pulse beams, the delay being given by the encoder; and inputting a plurality of beams which have been delayed to a plurality of optical interferometers, and wherein an optical path length difference L(j+1) of a (j+1)-th optical interferometer and an optical path length difference (j) of a j-th optical interferometer have a relation of (L(j+1)=rL(j)), where r is a coefficient which is any non-integer real number.
